(19) United States
(12) Patent Application Publication
(10) Pub. No.: US 2003/0228126 A1
(43) Pub. Date: Dec. 11, 2003

(54) Multiple programmable video recorder using interleaved writes

(76) Inventor: Mark J. Buxton, Chandler, AZ (US)

Correspondence Address: Timothy N. Trop, Trop, PRUNER & HU, P.C., 8554 KATY FWY, STE 100, HOUSTON, TX, 77024-1841, US

(21) Appl. No.: 10/163,678

(22) Filed: Jun. 5, 2002

(51) Int. Cl. H04N 5/76; H04N 5/781

(52) U.S. Cl. 386/46; 386/125

(57) ABSTRACT

In accordance with some embodiments of the present invention, multiple audio/video programs, such as television or radio programs, may be stored using interleaved writes to a storage device such as a hard disk drive. A segment from a first A/V stream may be stored, followed by a segment of a second A/V stream, in turn followed by a segment from the first A/V stream, and so on. As a result, in some embodiments, the number of write seeks may be reduced.

### BACKGROUND

This invention relates generally to processor-based systems and, more particularly, to programmable video recorders.

A programmable video recorder is a recording device that may digitally record analog or digital audio or visual (“audio/visual” or “A/V”) programs such as television or radio programs. In some cases, more than one program may be recorded at one time. To do so a multiple stream programmable video recorder (multiple PVR) may be utilized.

A tuner may receive a plurality of programs and may pass them to an audio/video capture unit. The capture unit may provide video encoding and audio encoding especially if analog signals are received.

When digital programming is received, the video encoding may be unnecessary since the programming may already be in a suitable format. On playback, the stored data may be decoded and then rendered for display.

The encoded data is then stored on an audio/visual store. The store may be a file or group of files on a disk holding the audio/visual programs for subsequent playback. This file may include a set of blocks (typically of the same size) that correspond to convenient and efficient disk or file system access units. For example, a block may be a single physical sector.

In a multiple PVR, multiple read or write streams are used to support multiple viewers or simultaneous recording of multiple sources. Multiple PVRs serialize access to a hard disk drive or provide multiple hard disk drives.

The multiple PVR with a single hard disk faces a large number of write seeks. A write seek is a seek of the hard disk drive head while writing the block of data. With multiple PVRs, a large number of write seeks occur as the file system write alternates between the various streams.

Relying on a file system, such as ext2, to efficiently handle multiple write streams also invariably results in disk fragmentation. Write seeks are required to transition between unfragmented files. With fragmented files, early in the life of the file system, seeks may be reduced and throughput is high. Eventually, however, the number of seeks from the fragmented file system is very large.

Thus, there is a need for a way to enable multiple PVRs that reduce write seeks.

### BRIEF DESCRIPTION OF THE DRAWINGS

FIG. 1 is a schematic depiction of one embodiment of the present invention;

FIG. 2 is a schematic depiction of another embodiment of the present invention;

FIG. 3 shows schematically the storage of blocks in accordance with one embodiment of the present invention;

FIG. 4 is a flow chart useful in accordance with one embodiment of the present invention; and

FIG. 5 is a flow chart useful in accordance with one embodiment of the present invention.

### DETAILED DESCRIPTION

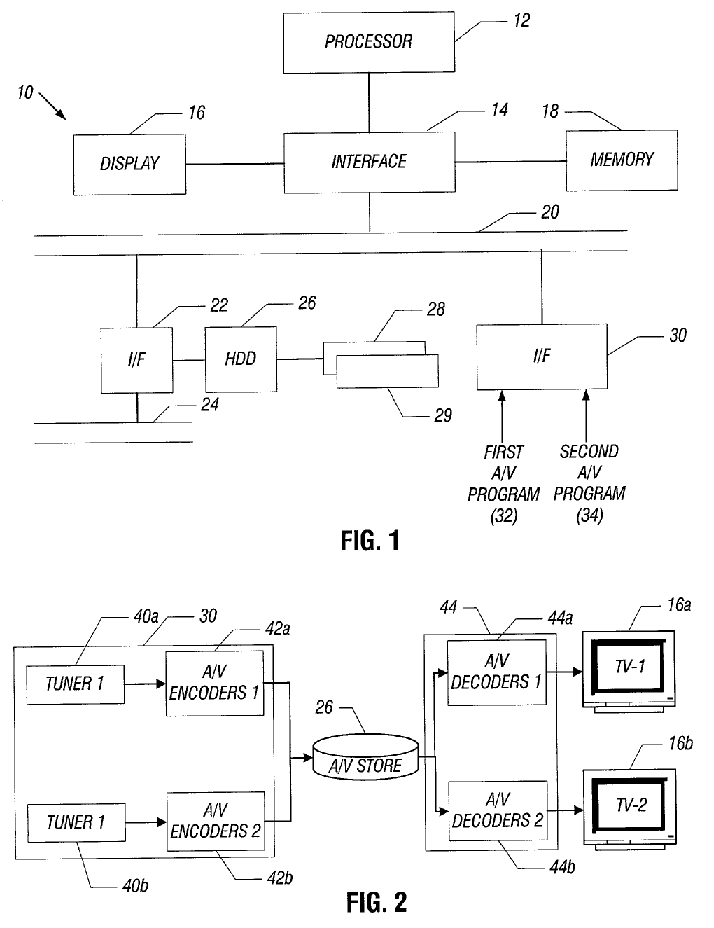

Referring to FIG. 1, a processor-based multiple PVR system 10 may be a set top box, a personal computer system, an audio video system, or a television, to mention a few examples. The system 10 may include a processor 12 coupled by an interface 14 to a system memory 18 and a display 16. The interface 14 in one embodiment may be a bridge.

The interface 14 may be coupled to one or more buses 20. The bus 20 may in turn be coupled to an interface 22 that, in one embodiment, may also be a bridge. The interface 22 may be coupled to another bus 24 and to a hard disk drive 26. The hard disk drive 26 may store software programs 28 and 29.

An interface 30, such as an encoder, receives a first A/V program 32 and a second A/V program 34. In some embodiments, more than two A/V programs may be received. An A/V or audio/visual program is a program, such as a television or a radio program, that includes either audio or video or both audio and video information. The programs 32 and 34 are intended to be stored using a multiple PVR on the hard disk drive 26.

Thus, in accordance with one embodiment of the present invention, shown in FIG. 2, a receiving unit 30 may include a first tuner 40a and a second tuner 40b. Each tuner 40 may be tuned to receive a particular program desired by the user. The tuners 40 may be each coupled to A/V encoders 42 for encoding in an appropriate format. For example, the received audio/video information, if not already suitably encoded, may be encoded and compressed in accordance with one of a variety of formats to increase the storage capacity of the hard disk drive 26.

The encoders 42 provide the information to an A/V store 26. The A/V store may be a file or group of files on the hard disk drive 26 holding the audio and video streams for subsequent playback. The files may consist of a set of blocks, typically of the same size, that correspond to convenient and efficient disk or file system access units. For example, a block may be a single physical sector on the hard disk drive 26.

The playback system 44 includes A/V decoders 44a and 44b for each program. In one embodiment, each decoder 44a or 44b may be coupled to a separate display 16a or 16b. For example, the displays 16a and 16b may each be the displays of a television system. However, in some embodiments, only a single display may be needed and, thus, only a single decoder 44a may be needed since only one program may be viewed at a time even though multiple programs may be stored at the same time.

By interleaving writes to the A/V store 26 at the application level, unnecessary write seeks may be avoided by introducing a certain amount of forced fragmentation. This fragmentation, however, may be under control of a PVR application rather than being under the control of the file system. If one of the two streams is erased, the extra space in the storage system is vacant and is not returned to the operating system. Thus, eventually, the PVR 10 archive may consist of only half as many streams as would be possible otherwise.

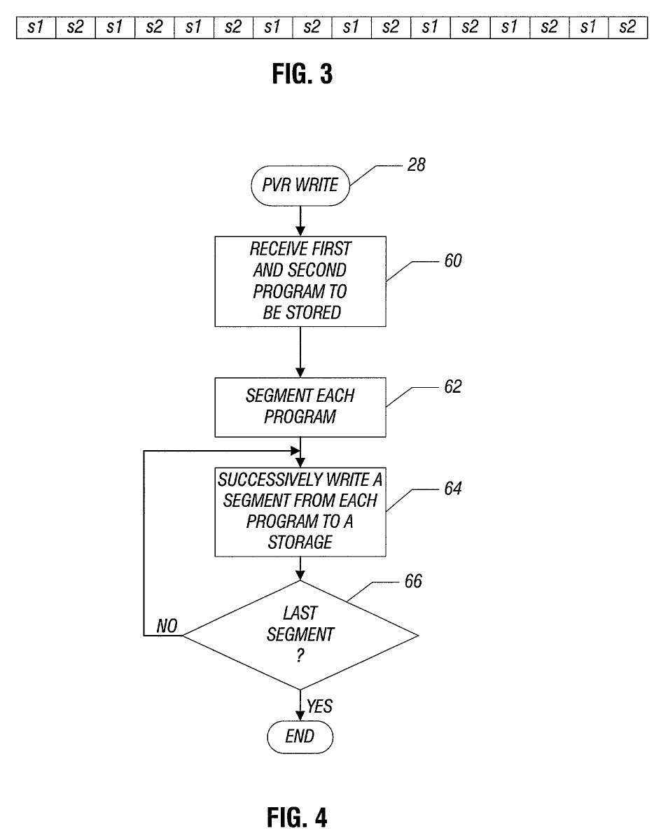

Thus, as shown in FIG. 3, the first audio program 32 may form a stream with blocks S1 and the second audio video program 34 may form a stream with blocks S2. A block S1 may be stored in a file followed by a block S2 followed by a block S1 and so on to form an interleaved file which is necessarily fragmented.

For N streams, the write duration is N times longer than for a single block write. However, because no seeks are involved in the write and because hard disk drive throughput is typically greater than a single stream write bandwidth, the additional write bandwidth is not necessarily a bottleneck.

The interleaving may occur by a variety of different mechanisms. For example, the PVR application can write multiple streams within the same block or the streams can be written to separate blocks and the blocks written sequentially. Writing the streams to separate blocks so that the blocks are written sequentially may be advantageous because subsequent reads may more efficiently read an entire block and reads are unlikely to read each stream from the same location.

Reads need not be any worse than in a system using two or more separate PVRs. If the write blocks from each stream are written sequentially, then the read access pattern for each stream will be: read block 1, read block 3, read block 5, read block 7, etc. for a dual stream PVR. Hence, N-1 blocks are skipped for each block read, where N is a number of write streams in the PVR. If the blocks are close together, the hard disk drive head will not seek. If the N write streams are interleaved within a block, then the blocks are read sequentially for each stream.

In accordance with one embodiment of the present invention, streams may be deleted from the A/V store 26. When files are deleted, the unused space in the A/V store is not returned to the file system until all the streams are deleted in one embodiment.

Thus, referring to FIG. 4, the software 28 for writing to the A/V store 26 begins by receiving the first and second A/V programs 32 and 34 to be stored, as indicated in block 60. Each program 32 or 34 may then be segmented into blocks as indicated in block 62. A segment from each program 32 or 34 is alternatively written to the storage as indicated in block 64. A check at diamond 66 indicates whether or not the last segment has been stored. If so, the flow ends. Otherwise, the flow iterates.

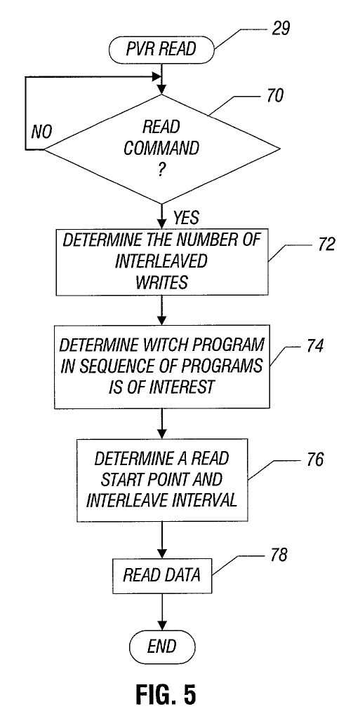

The read operation, implemented with the PVR read software 29, shown in FIG. 5, begins by determining whether a read command has been received, as indicated in diamond 70. If so, the number of interleaved writes is determined as indicated in block 72. Next, the system determines which program in the sequence of programs is of interest as indicated in block 74. Using this information, a read start point and an interleave interval is determined as indicated in block 76. Then the data may be read starting from the start point and using the interleave interval to avoid reading back the interleaved data from another program, as indicated in block 78.

In some embodiments of the present invention, multiple write, single read usage paradigms may be implemented with only about a twenty-five percent increased peak latency for worse case writes, relative to a single stream write/read usage. In some embodiments, a multiple stream PVR can be implemented on existing technology hard disk drives with some remaining input/output bandwidth for unrelated transactions. Any number of programs may be interleaved. Asymmetric PVRs with larger number of writes than reads are implementable on existing infrastructure. The system can be efficiently implemented on any general purpose file system, avoiding recourse to specialized streaming file systems. The system may be extensible to both analog and digital PVR systems.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
receiving first and second audio/visual programs;
segmenting each program into segments; and
interleaving a write of a segment from the first program to a storage with a write to the storage of a segment from the second program.

2. The method of claim 1 including storing said segments from said first and second programs in abutting regions of a storage.

3. The method of claim 1 including storing said first and second programs on a hard disk storage.

4. The method of claim 3 including erasing the first program and reserving the space used by said first program until said second program is erased.

5. The method of claim 3 including storing said programs to prevent write head seeking during said writes.

6. The method of claim 1 including using an application program to interleave said writes.

7. The method of claim 6 including defragmenting the stored programs.

8. The method of claim 1 including interleaving writes of said first and second programs to successive blocks in said storage.

9. The method of claim 8 including interleaving writes of audio and video data in said first and second programs.

10. The method of claim 9 including writing an audio portion of said first program to a first area of a first block and writing a visual portion of said first program to a second area of said first block.

11. An article comprising a medium storing instructions that, if executed, enable a processor-based system to perform the steps of:
receiving first and second audio/visual programs;
segmenting each program into segments; and
interleaving a write of a segment from the first program to a storage with a write to the storage of a segment from the second program.

12. The article of claim 11 comprising a medium storing instructions that, if executed, enable a processor-based system to perform the step of storing said segments from said first and second programs in abutting regions of a storage.

13. The article of claim 11 comprising a medium storing instructions that, if executed, enable a processor-based system to perform the step of storing said first and second programs on a hard disk storage.

14. The article of claim 13 comprising a medium storing instructions that, if executed, enable a processor-based system to perform the step of erasing the first program and reserving the space used by said first program until said second program is erased.

15. The article of claim 13 comprising a medium storing instructions that, if executed, enable a processor-based system to perform the step of storing said programs to prevent write head seeking during said writes.

16. The article of claim 11 comprising a medium storing instructions that, if executed, enable a processor-based system to perform the step of using an application program to interleave said writes.

17. The article of claim 16 comprising a medium storing instructions that, if executed, enable a processor-based system to perform the step of fragmenting the stored programs.

18. The article of claim 11 comprising a medium storing instructions that, if executed, enable a processor-based system to perform the step of interleaving writes of said first and second programs to successive blocks in said storage.

19. The article of claim 18 comprising a medium storing instructions that, if executed, enable a processor-based system to perform the step of interleaving writes of audio and video data in said first and second programs.

20. The article of claim 19 comprising a medium storing instructions that, if executed, enable a processor-based system to perform the steps of writing an audio portion of said first program to a first area of a first block and writing a visual portion of said first program to a second area of said first block.

21. A processor-based system comprising:
a processor;
a port coupled to said processor to receive a first and a second audio/visual program; and
a storage storing instructions that enable the processor to segment each program into segments and to interleave a write of a segment from the first program with a write of a segment from the second program.

22. The system of claim 21 wherein said storage is a hard disk drive.

23. The system of claim 22 wherein said storage stores instructions that enable the segments from the first and second programs to be stored in abutting regions of said storage.

24. The system of claim 21 wherein said storage stores instructions that enable the processor to erase the first program while reserving the storage space used by the second program until the second program is erased.

25. The system of claim 23 wherein said storage stores instructions that enable the programs to be stored in a way that prevents write head seeking during said writes.

26. The system of claim 21 wherein said storage stores instructions including an application program that controls the interleaving of said writes.

27. The system of claim 25 wherein said application program controls the fragmentation of the programs.

28. The system of claim 21 wherein said storage stores instructions that enable the interleaving writes of said first and second programs to successive blocks in said storage.

29. The system of claim 28 wherein said storage stores instructions that result in interleaving writes of audio and visual data in said first and second programs.

30. The system of claim 29 wherein said storage stores instructions that enable the processor to write an audio portion of the first program to a first area of a first block and to write a visual portion of the first program to a second area of a first block.
